(19) United States
(12) Patent Application Publication
(10) Pub. No.: US 2009/0321534 A1
(43) Pub. Date: Dec. 31, 2009

(54) Aerosol or gaseous decontaminant generator and application thereof

(75) Inventors: Virgil Flanigan, Rolla, MO (US); Shubhender Kapila, Rolla, MO (US)

Correspondence Address: HOVEY WILLIAMS LLP, 10801 Mastin Blvd., Suite 1000, Overland Park, KS, 66210, US

(73) Assignee: NFD, LLC

(21) Appl. No.: 11/292,720

(22) Filed: Dec. 2, 2005

(51) Int. Cl. B05B 1/24

(52) U.S. Cl. 239/13; 239/135

(57) ABSTRACT

Disclosed is a generator for the production of an oil based aerosol or a gaseous vapor, which can be used for decontamination of an area, by heating petroleum fuels, plant oils, animal fat derived oils, or light mineral oils in the temperature range of from 250° C. to 800° C., ±5° C. The generator is capable of producing oil particles of a diameter of about 0.04 microns to 3 microns, the most preferred diameter being of about 0.15 microns to 1.5 microns. A condensing trap distal to a concentric tubular oven, which is used to heat the oil, removes non vaporized oil particles from the smoke to produce a gaseous vapor having the advantage of leaving no residue in the area following the decontamination process. An additional filter apparatus controls the size of the oil particles released into the environment.

### BACKGROUND OF THE INVENTION

1. Field of the Invention

The invention is directed to a device and a method for generating a vapor and an aerosol from oil. Specifically, the invention is directed to a device and a method for generating a vapor and aerosol that have antimicrobial activity. Further, the invention is directed to a method of decontaminating a space.

2. Description of the Related Art

It is generally known in the art that to produce smoke, a hot gas, usually hot air, is in some way put in contact with a smoke generating fluid. This fluid may be either heated or unheated prior to association with the hot gas. The air heats the smoke generating fluid and vaporizes it while at the same time cooling the air to create the fog or smoke. In this general method, a considerable amount of time is needed for sufficient hot air to heat the smoke fluid to a level to create a substantial amount of vapor. Thus vaporizing smoke builds up slowly in the hot air with a consequent slow build up of fog, smoke or vapor.

In another known method, a pool of smoke generating fluid is heated to a vaporizing temperature, then heated or unheated air is blown through the vapor to create smoke. According to this method, a considerable amount of time is required to heat the fluid to a level for vaporization and there is significant time required for contact between the vapor and air such that the density of the smoke slowly increases then slowly decreases.

In yet another known method, the smoke fluid is atomized and aerosolized directly into a forced air stream. The smoke created by this method is relatively cold and as such has a density greater than air and tends to settle downward rather than rising to fill an area or to provide an effective smoke screen. Another method in the art mixes steam with smoke fluid to vaporize the fluid. The resulting vapors are passed through a confined orifice into the atmosphere where upon cooling of the steam and smoke fluid vapor a smoke is produced.

Smoke oil generators all generally constructed from basically two functional plans; those generators in which the oil fog is generated by atomization of oil particles into the environment simply by compressed air forcing oil through a small nozzle dispersing the oil into a cloud as described in U.S. Pat. Nos. 5,609,798; 4,836,452. In other generators this atomization is enhanced by passing to the oil droplet cloud through a heating plate or block heated by electrical resistance the source of which is supplied by a 12 volt battery as described in U.S. Pat. Nos. 5,922,944 and 6,439,031B1. The most common smoke generator, however, is that in which a smoke oil is heated by an electrical resistance means in a narrow space to above oil vaporization temperature to produce oil droplets which, when cooled either in a chamber means or upon release into the environment, produces an obscuring black or white smoke. Another means of heating the smoke producing oil is to use exhaust gases from a conventional or modified combustion engine operating by the combustion of an air:fuel mixture U.S. Statutory Invention Registration H765 and US patents described following. Nearly without exception these systems produce smoke by release of an oil droplet oil cloud from a high temperature environment into a cooler exterior environment for the purpose of producing an obscurant cloud such as described in U.S. Pat. Nos. 6,400,897B1, 4,419,219 and others described following, for insertion into a system to be examined for leaks such as that described in U.S. Pat. Nos. 5,107,698; 5,859,363; 5,753,800; 4,300,428; or for fire control training by producing a smoke cloud similar to that which might be encountered by a fire fighter as described in U.S. Pat. Nos. 4,349,723; 5,870,524 and others described following.

Other methods of atomization of materials into a defined space include those found in home deodorizers. In these vapor generators oil drawn through a heating source by a wicking apparatus vaporizes and either diffuses into the environment or is accelerated into the environment by a fan apparatus means. These vaporizers can be designed to apply a DC voltage to a wick-like, porous emitter or generator assembly supplied with a liquid to be vaporized. Liquids used in this type of vaporizer can be a disinfectant, an aromatic oil, deodorant, microbicide, including fungicides, bactericides, or insecticides, or a fumigant. These vaporizers can be mounted in a room space or within an HVAC system to facilitate dispersal. Vaporizers of this type are described for example in U.S. Pat. Nos. 5,382,410; 4,136,038; 4,171,340; 6,349,168 B1; 6,773,679. Other vaporizers are those such as described in U.S. Pat. Nos. 4,777,345; 5,991,507; 4,687,904; and 4,731,522.

### SUMMARY OF THE INVENTION

The inventors have developed an improved device (generator) and method for generating oil vapor and/or oil aerosol. The generator and method combine the generation of oil aerosol and vapor generation using heat and compression with a condenser and filter system to control the aerosol particle size or to eliminate aerosols from generated vapor. Also unique is the utilization of this generator and method for the purpose of producing an aerosol or gaseous vapor disinfectant derived preferably from plant oil, preferably soybean oil, or methylated derivatives of plant oils such as methyl soyate for example.

The generator functions to heat a smoke oil source be it a plant oil, methyl derivatives thereof, a petroleum oil, diesel oil, oil derived from animal fat or any other oil or methyl derivatives or any other structural derivatives of oils such as these to its vaporization point. The generator is designed to remove any non-vaporized oil from the resulting smoke via a condensing trap, filter the smoke to remove all but the desired size oil particles or all oil products such that a gas vapor is released to produce obscurant smoke and/or to produce an aerosol or gaseous vapor. This vapor or aerosol can be used to disinfect small and large spaces contaminated with microorganisms including but not exclusive of virus, virus particles, bacteria, bacterial spores, fungi and fungal spores and yeasts. The spaces to be disinfected include but are not exclusive of, commercial and military aircraft and vehicles used to transport materials, foodstuffs, personnel and any other items that are commonly carried by these means, military installations including among other spaces, barracks, offices, hospitals, storage facilities, vehicles, and laboratories used for medical or research and development; agricultural production systems; post office mail stream; historic artifacts including those of cellulose, lignin, collagen, keratin, or chitin composition; spaces housing these artifacts including museums, archeological digs, vaults, warehouses, libraries among others. Also of value to disinfect with the technology previously disclosed using the generator disclosed herein are passenger and cargo ships, truck trailers and train cars, hospital rooms, hospice and controlled residential facilities such as day care centers, nursing homes and extensions thereof, long- short- and intermediate-term care facilities, and prisons and jails. This technology could be adopted by NASA for decontamination of their facilities and vehicles and by other governmental agencies for use as needed.

In agricultural the production of eggs or chickens or of dairy or beef cattle and other live stock for market leads to contamination of the production facilities and eventually the products produced in these facilities with organisms such as E. coli O157H, Salmonella spp., Campylobacter spp., Listeria spp, and other enteric bacteria which when incorporated into the food chair become food borne emerging pathogens. Anthrax is a common contaminant in cattle and dairy production. The technology and generator can be used to “clean” these areas making it safe for workers employed in the contaminated areas and for the public who purchase the products for consumption. Legionella is often a contaminant of HVAC systems and infection by this pathogen of immuno compromised individuals can lead to death. The generator could be used to move an effective disinfectant into and through HVAC systems. An example of probable use would be to decontaminate U.S. Senate office building offices exposed to Bacillus anthracis. Another example is decontamination of chicken raising facilities of Salmonella and other bacterial facilities or of livestock rearing areas and slaughter houses of bacteria associated with production. Still other examples might be the use in decontaminating aircraft between passenger flights. Cruise ships recently have been the source of bacterial infections leading to wide spread sickness amongst the travelers; this is yet another potential use. Artifact materials are destroyed by bacteria and fungi thus a potential use would be in the routine decontamination of museums, libraries and archives housing these materials or of these materials recovered on archeological dig sites. These are but a few examples for potential use and other uses of this generator and the associated disinfectant technology are limited only by one's imagination.

### DESCRIPTION OF THE DRAWINGS

FIG. 1: Basic schematic of furnace means. An oil source is fed via a pump means into a conducting tube heated by a furnace means where it is heated above its vapor temperature. Insertion of air into the conducting tube produces an aerosol cloud which passes by a cold trap condenser to remove excess oil from the smoke or fog produced boy heating. The resulting smoke then passes by two sampling ports/air chambers from which samples can be withdrawn for testing. The oil vapor then passes through a filter stage whereby particle size can be selected.

FIG. 2: Detailed drawing of generator means described in FIG. 1.

FIG. 3: Schematic drawing of smoke generator described herein showing basic design of generator tube means for production of smoke/aerosol resulting from heating a selected fog oil to above vaporization temperature.

FIG. 4: Schematic drawing of filter assembly.

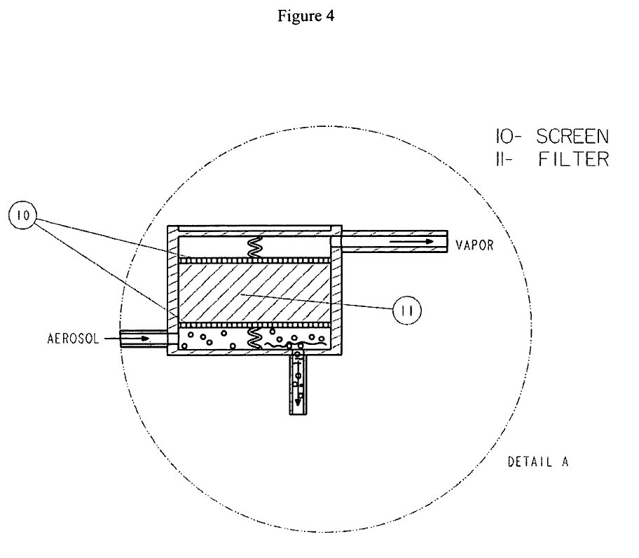

### DETAILED DESCRIPTION OF A PREFERRED EMBODIMENT OF THE INVENTION

The invention described is that of a generator for production of a oil based aerosol or a gaseous vapor generated there from to be used for decontamination of spaces and areas, including but not exclusive of, rooms, laboratories, cargo carriers, air craft, HVAC systems, historic artifacts and documents, agricultural production facilities, hospital facilities, office spaces, and all other areas or facilities accessible to the apparatus as described for microorganisms including but not exclusive of viruses and viral particles, bacteria, bacterial spores, fungi, and fungal spores and yeasts. The generator is capable of producing either an aerosol or a gaseous vapor developed from the aerosol by heating petroleum fuels, plant oils, animal fat derived oils, or light mineral oils in the temperature range of from 250° C. to 800° C. with a tolerance of ±5° C. The generator is capable of producing oil particles of any size within the range of 0.04 microns to approximately 3 microns in diameter with the most preferred size being in the range of approximately 0.15 microns to 1.5 microns in diameter. The addition of a unique condensing trap means into the stream of smoke movement immediately after the thermostat-controlled (thermostated) concentric tubular oven used to heat the producing oil source allows removal of excess non vaporized oil particles from the smoke to produce a gaseous vapor capable of the desired decontamination effectiveness and with the enhanced advantage of leaving no residue following the decontamination process. A filter apparatus means placed in the vapor flow stream controls the size of fog oil particles released or removes all residual non-vaporized fog oil from being released into the environment.

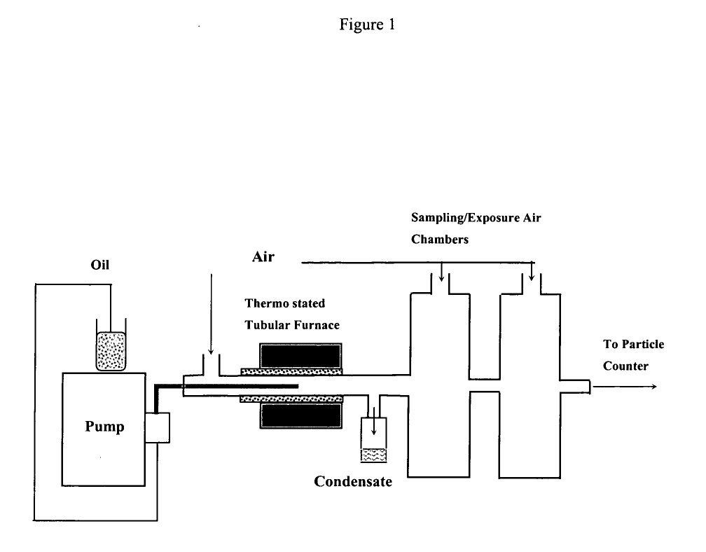

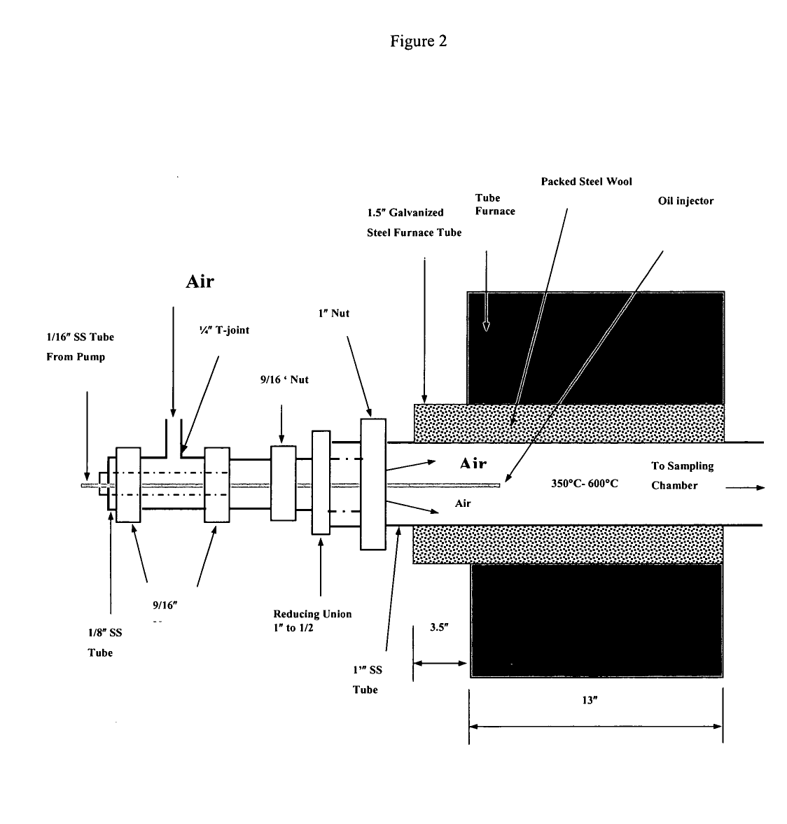

Oil flow rate in the generator is optimal in the range of approximately 0.02 milliter per minute to 10.5 ml per min with a flow rate of at least 0.1 ml per min. Air flow rate into the condenser for the purpose of moving the aerosol smoke through the transfer tubes into the particle size filters and through the exhaust port into the atmosphere is at a minimum of 3 Liters per minute in a laboratory sized generator as shown in FIGS. 1 and 2. This air flow rate is increased and controlled by an air compressor means in larger generators to a range between 3 liters per minute and 50 to 100 liters per minute depending upon the size of the generator and the preferred embodiment of its use.

The preferred oil for generation of a disinfectant aerosol or gaseous vapor is a plant oil including but not exclusive of soybean oil, corn oil, sunflower seed oil, rape seed oil, or linseed oil and the methyl esters thereof, petroleum oil including diesel fuel such as, but not exclusive of, JP4, JP8, MOGAS or other petroleum based oils, light mineral oil, or oils derived from animal fat and the methyl esters thereof.

The disclosed apparatus as shown in FIG. 1 comprises an oil reservoir from which oil is pumped via a dual piston pump means through a controlled diameter tube through which the oil flows at a controlled rate of from 0.1 ml/min to 100 ml/min into thermostat-controlled (thermostated) concentric tubular oven means capable of heating the oils to or above their vaporization temperatures resulting in the production of a smoke containing oil droplets of a desired size. The smoke is moved by a stream of compressed air produced by an air compressor means along a hollow delivery tube means where a degree of cooling occurs and passed by an oil condensate collector means where non aerosolized oil droplets can be removed. The smoke then is forced into a filter chamber means where by the size of oil droplets in the final aerosol is selected or where all oil droplets are removed such that only a gaseous vapor is exhausted.

In a laboratory sized generator the vapor/aerosol producing oil is flowed into the tubular furnace means at a constant rate of from 0.1 ml/min to 100 ml/min; flow rate is dependent on the size of the generator and can be increased 100 to 1000 fold over that in the laboratory sized generator as needed for the preferred embodiment. The thermostat controlled concentric tubular furnace is heated by an electric resistance means and is controlled in the range of 250° C. to 800° C. depending on the type of oil and the desired result of vaporization. A compressed air stream generated from an air compressor means is used to force the vaporized oil as a smoke out of the furnace means through a delivery tube (a.k.a. transport tube), passing over a oil condensate collector means either external to, or included in, a size selective screen filter chamber means containing filter means (e.g., cold trap condenser and the to select the size oil droplets exhausted or to remove all oil droplets from the smoke allowing only a gaseous vapor to be emitted from the generator. A glass lined chamber fitted with sampling ports can be inserted between the filter means and the exhaust means for the purpose of sampling the exhausted material for particle size, chemical composition and/or toxicity (FIG. 1).

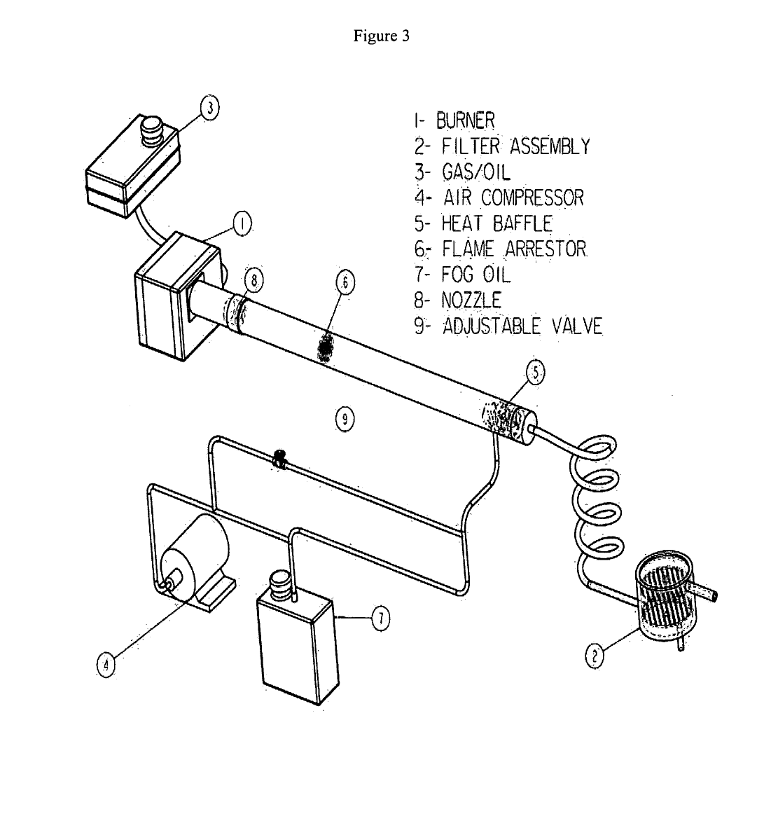

In the preferred embodiment of the invention a smoke containing oil particle size from approximately 0.04 microns in diameter to approximately 2 microns in diameter is produced for release into the environment for effective decontamination of microorganisms including, but not exclusive of, virus and viral particles, bacteria, bacterial spores, fungi, fungal spores and yeasts. In a more preferred embodiment oil particles are produced in the size range of 0.15 microns in diameter to 1.5 microns in diameter. In the most preferred embodiment only a gaseous vapor from which all oil particles have been removed into the oil condenser means and/or by the filter chamber means is released into the environment as a microbial decontaminant (FIG. 3, 3A, 3B). In the preferred embodiment of this invention the smoke oil source is can be petroleum fuel such as a diesel fuel, a light mineral oil or oil derived from animal fats or the methyl esters thereof. In the more preferred embodiment the oil source is plant oil or methyl derivatives of plant oil derived from, but not exclusive of, cotton seed oil, sunflower seed oil, linseed oil, or rape seed oil. In the most preferred embodiment the smoke oil source is soy bean oil or its methyl or other derivatives.

FIG. 1 shows the overview of the aerosol/vapor generation apparatus disclosed herein. The dual piston pump means delivers smoke-producing oil from an oil reservoir through a narrow diameter tube opening into a thermostat controlled concentric tubular furnace. The delivery tube inserts into the furnace through a metal conduit tube containing at its proximal end a portal inlet for a high velocity air stream derived from and controlled by an air compressor means exterior to the generator. The oil is dispersed by the air stream in the furnace means where the oil is vaporized by heating to a temperature above the vaporization temperature of the oil. The resulting smoke is moved by the air stream through a carrier tube containing an outlet port to a condenser oil condenser means where oil that has not been vaporized is condensed and removed. The smoke then is moved into a filter chamber means where oil droplets of unwanted size are removed and vapor is emitted through the exhaust port in the filter chamber means or where all oil residues are removed and a gaseous vapor with disinfectant properties is released into the atmosphere. A glass lined sampling chamber can be affixed to the exhaust port of the filter chamber means to allow sampling of the aerosol or gaseous vapor produced for chemical, particle size or toxicological analysis. An exhaust port from the sampling member then is used to move the desired material into the environment.

FIG. 2 provides details of the oil inlet portion of the aerosol/gaseous vapor generator designed for use in the laboratory. Oil is introduced into the furnace through a 1/16″ SS tube. This tube is inserted into a ⅛″ SS tube itself inserted into a ¼″ carrier tube. A ¼″ T-joint with a port for attachment to a compressed air supply means is inserted into the carrier tube immediately distal to the entry point of the oil supply tube means. The carrier tube inserts into a 1.5″ OD Galvanized steel furnace tube with a ½ tubular core. The furnace tube is insulated with packed steel wool and is inserted into a 13″ tube furnace block.

FIG. 3 (3A-3B): Schematic drawing of the smoke generator described in this embodiment in its basic design for production of smoke/aerosol. In this embodiment a petroleum based heating fuel is ignited to provide a flame which produces the temperature needed to vaporize the selected fog oil means. The flame is contained by a flame arrestor inserted into the generator tube means and fog oil means contacts only the heat produced by the flame. This embodied generator with the added selective terminal filter unit is detailed in FIG. 3B. Addition of the filter unit with changeable, particle size defined filters and screens provides control over the size of fog oil particles released into the atmosphere from the terminal end of the generator tube means. This unit allows adjustment of the fog oil generator means for embodiment of the chosen application including but not inclusive of generation of an obscurant fog or of a vapor used for decontamination of varied size public, private, or commercial areas and surfaces. A condenser trap is included on the ventral side of the filter trap means as a means for removing non-vaporized fog oil and/or particles rejected by the screen/filter means within the filter means apparatus. In this embodiment aerosol produced heating a preferred fog oil including but not inclusive of petroleum based oil products, light mineral oils, plant oils including but not inclusive of soy bean oil, canola oil, linseed oil, cotton seed oil, sunflower seed oil, corn oil or their methyl, ethyl, acetyl, or other modified and volatile derivatives, or animal fat derived oils and their modified derivatives passes from the smoke generator tube means into the ventral chamber of the selective filter means. The vapor/aerosol rises within the filter means to pass through a ventral selective size screen into a selective sized filter means. Vapor particles too large to pass through the screen and filter means and non-vaporized oil particles are removed through a condenser means inserted into the ventral chamber of the filter means. Once passing through the selective filter means, the aerosol/vapor passes through a second selective-sized filter screen into the dorsal chamber of the screen filter chamber means and exits into the atmosphere via the distal exhaust port on the generator tube apparatus in a form selected by manipulation of the screen filter means to meet the desired embodiment of the generator apparatus means.

Several parameters of the generator herein described are controlled to maximize aerosol or gaseous vapor generation for the intended purposes dependent on oil type, desired oil flow rate, generation temperature and exhausted product. In the preferred embodiment the oil flow rate is controlled from a dual piston pump means at from 0.1 ml per minute to 10.0 ml per minute through a thermostat controlled concentric tubular heated by electrical resistance means and controlled over a temperature range of from 350° C. to 650° C. (±5° C.). In the most preferred embodiment the oil flow rate is adjusted to provide maximally effective volume of vapor required to decontaminate the area defined by use. These areas include but are not inclusive of agricultural production facilities, food production facility, poultry rearing facility, cattle or swine rearing or producing facility, bioweapons manufacturing facility, feed lot, slaughter house, sewage treatment plant, hospital, health clinic, battle field, ballast tank of ships, cabins of airplanes, hospital rooms including laboratories and surgery theaters, kitchen, mail handling facility, border crossing facility, school, office space, class rooms, research laboratories, meeting halls private homes, public arenas, theaters, performance halls or the like, private facilities and commercial facilities and the like. In the most favored embodiment the entire generator means is enclosed in an insulated metal encasement for easy safe transport and use.

The following Example describes the use of the smoke generator described herein to decontaminate areas contaminated with bacteria and bacterial spores.

### Example

### Demonstration of Antimicrobial Properties of Oil Aerosols (Smoke)

The most preferred embodiment of the smoke generator is as a means to produce a non-aerosol vapor for use in decontamination of commercial, public and private spaces of viral particles, bacteria and bacterial spores, fungi and fungal spores as detailed in US patent application (Production and Use of a Gaseous Vapor or Aerosol Product from Plant Oils or Light Oils as an Environmental Disinfectant). In this example methyl soyate was heated to above its vapor temperature and vaporized. The resulting “fog” was passed through the filter screen of the smoke generator means and exhausted into a chamber containing culture plates inoculated with several bacterial species. The material entering the chamber was a clear vapor which leaves no residue but is effective in decontaminating the chamber.

Fog oil and methyl soyate aerosols were tested for their toxicity toward various microbes. The oil aerosols used in this study were generated through a process that mimics the operation of a “fog oil smoke” generator used by the U.S. Army. The process involves volatilization and subsequent condensation of fog oils and soy oil esters yielding particles of approximately 0.5-1 micron in diameter, which are effective obscurants for visible light and stabile in ambient air for up to 30 minutes.

Plates containing enriched nutrient minimal agar (MNA) media were inoculated with Salmonella strains, placed into an exposure chamber, and exposed to fog oil or methyl soyate smokes for a duration ranging from approximately 30 seconds to 2 minutes. The smokes (oil aerosols) were generated by introducing 0.5 mL min⁻1 of oil into a stainless steel tube maintained at 350° C. Controls were plates containing MNA media that were placed in an exposure chamber for 30 minutes in the absence of exposure to oil aerosol. After exposure all plates were incubated at 37° C. for 24 hours and examined for the presence of Salmonella colonies. Examination of the MNA plates exposed to aerosols for various intervals of time showed that Salmonella colonies were present only on plates that were exposed to oil aerosol for less than 2 minutes. No colonies were observed on those plates that were exposed for longer time intervals, demonstrating that oil aerosol exhibits high toxicity towards Salmonella.

In a variation of the above experiment, MNA plates were covered with ordinary paper or paper tissues and exposed to oil aerosol (fog oil or methyl soyate) for 2 minutes or 5 minutes. The plates were removed from the chamber, inoculated with the bacterial cultures, incubated for 24 hours, and examined for the presence of bacterial colonies. No colonies grew, demonstrating that the microbicidal agent found in oil aerosols is able to penetrate paper while maintaining its effectiveness as a microbicide. In a variation of this paper experiment, examination of paper and paper tissue exposed to oil aerosol prior to inoculation plates gave results similar to those obtained with direct exposure plates. No Salmonella colonies were observed on plates exposed for intervals longer than two minutes. This result indicates that a microbicidal agent produced during aerosol generation of fog oil or methyl soyate readily diffuses through paper or wipe tissue, gets incorporated into the agar matrix, and makes the agar unfit for microbial growth.

In yet another variation of the above experiment, MNA plates were exposed to oil aerosols (fog oil or methyl soyate) and, after removal from the chamber, placed in a sterile hood for a period of from 5 to 30 minutes. The plates were then inoculated with the bacterial culture, incubated for 24 hours, and examined for the presence of bacterial colonies. Examination of plates exposed to oil aerosol prior to inoculation gave results similar to those obtained with direct exposure plates. No Salmonella colonies were observed on plates exposed for intervals longer than two minutes. This result demonstrates that the microbicidal agent produced during oil aerosol generation is incorporated into the agar matrix and makes agar unfit for bacterial growth.

To assess the toxicity of fog oil and methyl soyate aerosol toward a wider range of microbial strains, additional exposure experiments were carried out. The exposure experiments were repeated with MNA plates that were preinoculated with the organisms listed in Table 1 and exposed to fog oil and methyl soyate “smokes” for 2 minutes. After the exposure the plates were incubated for 48 hours at 37° C. and examined for the presence of microbial colonies. The results are summarized in Table 1. A plus sign (+) signifies microbial growth. A minus sign (−) signifies no growth or microbial death. No microbial colonies were observed in any of the plates exposed to the fog oil smoke, whereas some colonies were observed on Pseudomonas aeruginose plates exposed to methyl soyate aerosols.

TABLE 1
Microbes Tested for Toxicity of Fog Oil
and Methyl Soyate Aerosols for 2 minutes.

| Organism Used | Fog oil | Methyl soyate |
|---|---|---|
| Salmonella typhimurium | − | − |
| Klebsiella pneumonia | − | − |
| Escherichia coli 25922 | − | − |
| Pseudomonas aeruginosa | − | + |
| Enterobacter cloacae | − | − |
| Serratia marcescens | − | − |

What is claimed is:

1. A device for generating aerosol and vapor from a fluid, the device comprising a transport tube for transporting the fluid, a thermostat-controlled concentric tubular oven positioned circumferential to the transport tube, a fluid reservoir and a pump for injecting the fluid into the transport tube located at the proximal end of the transport tube, an air vent in the transport tube located proximal to the oven and distal to the pump, a filter unit for excluding aerosol particles having a diameter less than or equal to 4 microns, and an exit vent located at the distal end of the transport tube from which the aerosol or the vapor can escape into the environment.

2. The device of claim 1 wherein the thermostat-controlled concentric tubular oven comprises an outer tube furnace externally apposed and concentric to a steel furnace tube that is externally apposed and concentric to packed steel wool that is externally apposed and concentric to the transport tube.

3. The device of claim 3 wherein the oven comprises a fuel supply container, a burner, a flame nozzle, a flame arrestor and a heat baffle.

4. The device of claim 3 wherein the oven is heated by an electrical resistance means that can be controlled in the temperature range of 250° C. and 800° C., inclusively.

5. The device of claim 1 wherein the filter unit comprises an inlet port that allows a mixture that comprises the aerosol and the vapor to enter the filter unit, a first space for the accumulation of aerosol particles, an exit port leading from the first space to outside of the filter unit through which aerosol droplets can exit the filter unit, a first screen separating the first space from a filter, the filter, a second screen separating the filter from a second space, the second space for the accumulation of vapor, and an exit port leading from the second space to outside of the filter unit through which vapor can exit the filter unit.

6. The device of claim 5 wherein the filter is capable of (a) blocking the passage of those aerosol particles having a diameter greater than or equal to a particular size and (b) allowing the passage of the vapor and those aerosol particles having a diameter less than a particular size.

7. The device of claim 6 wherein the particular size is between 0.04 microns and 3 microns inclusively.

8. The device of claim 6 wherein the particular size is between 0.15 microns and 1.5 microns, inclusively.

9. The device of claim 6 comprising a cold trap condenser connected to the transport tube distal to the oven and proximal to the filter unit.

10. The device of claim 1 comprising a glass lined chamber fitted with sampling ports, located in the transport tube between the filter unit and exit vent.

11. The device of claim 1 wherein the fluid is an oil selected from the group consisting of soybean oil, corn oil, sunflower seed oil, rape seed oil, linseed oil, oils derived from animal fat, diesel fuel, light mineral oil, and methyl ester derivatives thereof.

12. The device of claim 1 wherein the fluid is a methyl ester derivative of soybean oil.

13. The device of claim 1 comprising a compressor for the delivery of compressed air into the air vent.

14. A method of generating an oil-based aerosol or a gaseous vapor comprising the steps of (a) flowing an oil through a tubular oven, which heats the oil to between 250° C. and 800° C., inclusively, to produce a vapor, (b) injecting a compressed air stream into the vapor, which propels the vapor out of the oven through a transport tube, (c) passing the vapor and resulting aerosol particles, which form from the combination of the vapor and air stream, over a cold trap condenser, to remove oil droplets, (d) then passing the vapor and remaining aerosol particles though a size selective filter, and (e) allow the vapor to be emitted into the atmosphere.

15. The method according to claim 14 wherein the filter excludes all aerosol particles and allows only the vapor to be emitted into the atmosphere.

16. The method according to claim 14 wherein the filter allows for the passage of a subset of aerosol particles having a diameter of less than 4 microns such that the vapor and the subset of aerosol particles are emitted into the atmosphere.

17. The method according to claim 14 wherein the filter allows for the passage of a subset of aerosol particles having a diameter of between 0.04 microns and 3 microns inclusively, such that the vapor and the subset of aerosol particles are emitted into the atmosphere.

18. The method according to claim 14 wherein the filter allows for the passage of a subset of aerosol particles having a diameter of between 0.15 microns and 1.5 microns inclusively, such that the vapor and the subset of aerosol particles are emitted into the atmosphere.

19. The method according to claim 14 wherein the oil is selected from the group consisting of soybean oil, corn oil, sunflower seed oil, rape seed oil, linseed oil, oils derived from animal fat, diesel fuel, light mineral oil, and methyl ester derivatives thereof.

20. The method according to claim 19 wherein the oil is a soybean oil or a methyl ester derivative of soybean oil.

21. A method for decontaminating a space by administering an oil vapor or mixture of oil vapor and oil aerosol particles into the space, wherein the oil vapor or mixture of oil vapor and oil aerosol being generated according the steps with a, the method comprising generating an oil aerosol or oil vapor having antimicrobial activity

22. A method of selectively destroying organisms within an enclosed area, comprising the steps of (a) introducing an oil vapor or an oil aerosol into the enclosed area at a rate sufficient to cause an anti-microbial concentration of oil vapor or oil aerosol to be reached, and (b) maintaining said anti-microbial concentration for a period of time sufficient for destroying the organisms.

23. The method according to claim 22 wherein the oil vapor or oil aerosol is produced by (a) flowing an oil through a tubular oven, which heats the oil to between 250° C. and 800° C., inclusively, to produce a vapor, (b) injecting a compressed air stream into the vapor, which propels the vapor out of the oven through a transport tube, (c) passing the vapor and resulting aerosol particles, which form from the combination of the vapor and air stream, over a cold trap condenser, to remove oil droplets, (d) then passing the vapor and remaining aerosol particles though a size selective filter, and (e) allow the vapor to be emitted into the atmosphere; and wherein the oil is selected from the group consisting of soybean oil, corn oil, sunflower seed oil, rape seed oil, linseed oil, oils derived from animal fat, diesel fuel, light mineral oil, and methyl ester derivatives thereof.

24. The method according to claim 23 wherein the oil is a soybean oil or a methyl ester derivative thereof.
